(19) United States
(12) Patent Application Publication
(10) Pub. No.: US 2026/0196413 A1
(43) Pub. Date: Jul. 9, 2026

(54) MULTILAYER ELECTRONIC COMPONENT

(71) Applicant: SAMSUNG ELECTRO-MECHANICS CO., LTD., Suwon-si (KR)

(72) Inventors: Eung Soo Kim, Suwon-si (KR); Su Yeon Lee, Suwon-si (KR)

(73) Assignee: SAMSUNG ELECTRO-MECHANICS CO., LTD., Suwon-si (KR)

(21) Appl. No.: 19/381,884

(22) Filed: Nov. 6, 2025

(30) Foreign Application Priority Data
Jan. 8, 2025 (KR) 10-2025-0003021
Mar. 26, 2025 (KR) 10-2025-0038935

(51) Int. Cl. H01G 4/232; H01G 4/30

(52) U.S. Cl. CPC H01G 4/2325; H01G 4/30

(57) ABSTRACT

A multilayer electronic component includes a body including a dielectric layer and internal electrodes alternately arranged with the dielectric layer and an external electrode disposed on the body and including an electrode layer including a conductive metal and a conductive resin layer disposed on the electrode layer. The external electrode includes a connection portion disposed on one surface of the body and a band portion disposed on another surface of the body. The conductive resin layer includes a first conductive resin layer disposed in the band portion and including Cu and a first resin and a second conductive resin layer disposed in the connection portion and including an intermetallic compound and a second resin.

### CROSS-REFERENCE TO RELATED APPLICATION(S)

This application claims benefit of priority to Korean Patent Application Nos. 10-2025-0003021 filed on Jan. 8, 2025 and 10-2025-0038935 filed on Mar. 26, 2025 in the Korean Intellectual Property Office, the disclosures of which are incorporated herein by reference in their entirety.

### TECHNICAL FIELD

The present disclosure relates to a multilayer electronic component.

A multilayer ceramic capacitor (MLCC), a multilayer electronic component, is a chip-type capacitor mounted on the printed circuit boards of various types of electronic products, such as imaging devices including liquid crystal displays (LCDs) and plasma display panels (PDPs), computers, smartphones, cell phones, circuits, such as on-board chargers (OBCs) or DC-DC converters of electric vehicles, and the like, to allow electricity to be charged therein and discharged therefrom.

With the recent advancements in miniaturization and higher capacitance of multilayer ceramic capacitors (MLCCs), ensuring high reliability of MLCCs has become increasingly important.

In order to improve MLCC reliability, a method of applying a conductive resin layer to external electrodes to absorb mechanical and thermal stress has been proposed. The conductive resin layer may be formed to have a structure including copper (Cu) and a base resin or a structure including an intermetallic compound (IMC) and a base resin.

Meanwhile, the base resin included in the conductive resin layer improves flexural strength of MLCCs. However, as a non-conductive material, the base resin may increase equivalent series resistance (ESR) of MLCCs. Consequently, attempts have been made to use intermetallic compounds (IMCs) as a conductive metal of the conductive resin layer to reduce the ESR of MLCCs. However, since IMCs tend to form fine bridges between metal particles, IMCs may be disadvantageous for improving the flexural strength of MLCCs, as compared to when Cu particles are used as a conductive metal of the conductive resin layer.

Therefore, even when applying the conductive resin layer to external electrodes to improve the flexural strength of the MLCC, structural improvements of external electrodes are needed to suppress the increase in ESR.

### SUMMARY

An aspect of the present disclosure is to suppress an increase in equivalent series resistance (ESR) that may occur when a conductive resin layer is applied to an external electrode.

However, the purpose of the present disclosure is not limited to the above-described contents and will be more readily understood as specific embodiments of the present disclosure are described.

According to an aspect of the present disclosure, a multilayer electronic component includes: a body including a dielectric layer and internal electrodes alternately arranged with the dielectric layer in a first direction, the body including first and second surfaces opposing each other in the first direction, third and fourth surfaces connected to the first and second surfaces and opposing each other in a second direction, and fifth and sixth surfaces connected to the first to fourth surfaces and opposing each other in a third direction; and an external electrode disposed on one of the third surface or the fourth surface and including an electrode layer including a conductive metal and a conductive resin layer disposed on the electrode layer. The external electrode includes a connection portion disposed on the one of the third surface or the fourth surface and a band portion disposed on the first surface or the second surface. The conductive resin layer includes a first conductive resin layer disposed in the band portion and including Cu and a first resin and a second conductive resin layer disposed in the connection portion and including an intermetallic compound and a second resin.

According to an aspect of the present disclosure, a multilayer electronic component includes: a body including a dielectric layer and internal electrodes alternately arranged with the dielectric layer in a first direction, the body including first and second surfaces opposing each other in the first direction, third and fourth surfaces connected to the first and second surfaces and opposing each other in a second direction, and fifth and sixth surfaces connected to the first to fourth surfaces and opposing each other in a third direction; and an external electrode disposed on one of the third surface or the fourth surface and including an electrode layer including a conductive metal and a conductive resin layer disposed on the electrode layer. The external electrode includes a connection portion disposed on the one of the third surface or the fourth surface and a band portion disposed on the first surface or the second surface. An intermetallic compound and Cu are dispersed in a resin of the conductive resin layer. A content of the intermetallic compound with respect to the resin in the connection portion is greater than a content of the intermetallic compound with respect to the resin in the band portion, and a content of the Cu with respect to the resin in the connection portion is less than a content of the Cu with respect to the resin in the band portion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to one and another embodiments of the present disclosure;

FIG. 2 is a cross-sectional view taken along line I-I′ of FIG. 1;

FIG. 3 is a cross-sectional view taken along line I-I′ of FIG. 1;

FIG. 4 is a cross-sectional view taken along line II-II′ of FIG. 1;

FIG. 5 is an exploded perspective view schematically illustrating a body according to an embodiment;

FIG. 6 is an enlarged view of region PA of FIG. 2;

FIG. 7 is an enlarged view of region PB of FIG. 2; and

FIG. 8 is a graph illustrating the results of measuring equivalent series resistance (ESR) in multilayer electronic components according to comparative example and examples.

### DETAILED DESCRIPTION

Hereinafter, embodiments of the present inventive concept will be described in detail with reference to the accompanying drawings. The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

In the drawings, the X-direction may refer to a first direction or thickness direction, the Y-direction may refer to a second direction or length direction, and the Z-direction may refer to a third direction or width direction. A stacking direction of internal electrodes or dielectric layers may be the thickness direction or the width direction.

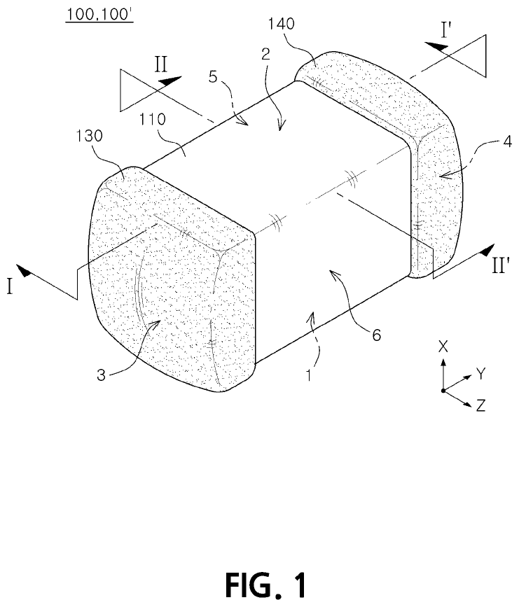

FIG. 1 is a perspective view schematically illustrating a multilayer electronic component according to one and another embodiments of the present disclosure.

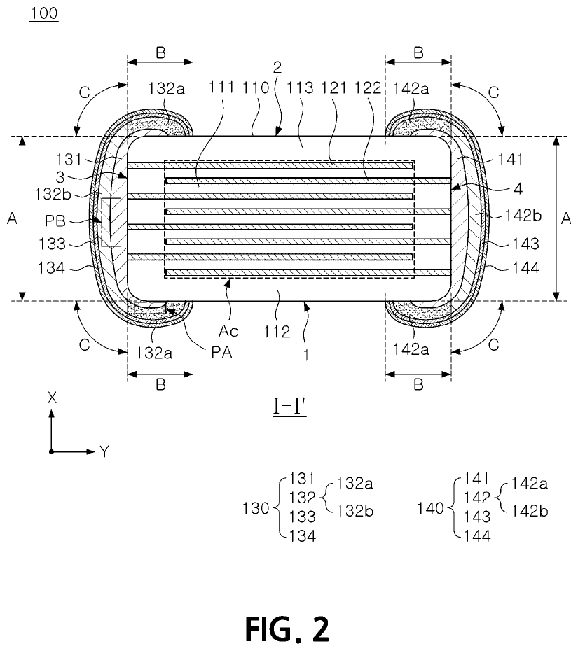

FIG. 2 is a cross-sectional view taken along line I-I′ of FIG. 1.

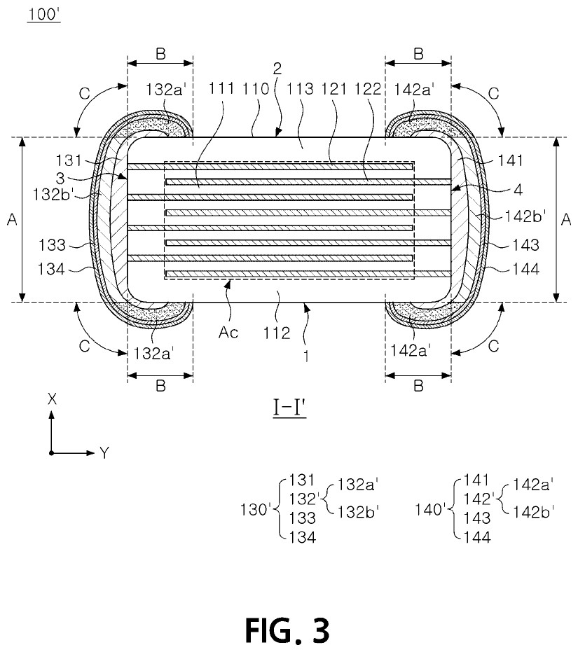

FIG. 3 is a cross-sectional view taken along line I-I′ of FIG. 1.

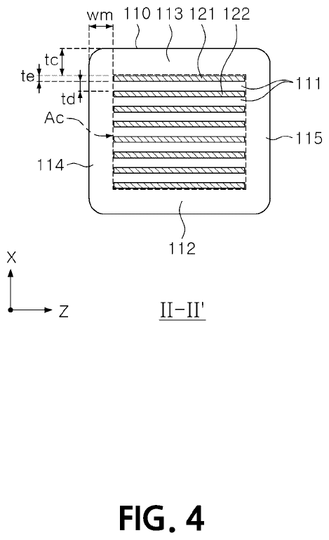

FIG. 4 is a cross-sectional view taken along line II-II′ of FIG. 1.

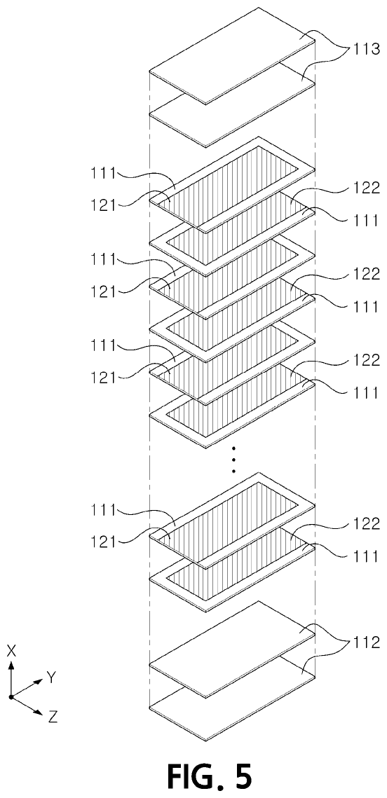

FIG. 5 is an exploded perspective view schematically illustrating a body according to an embodiment.

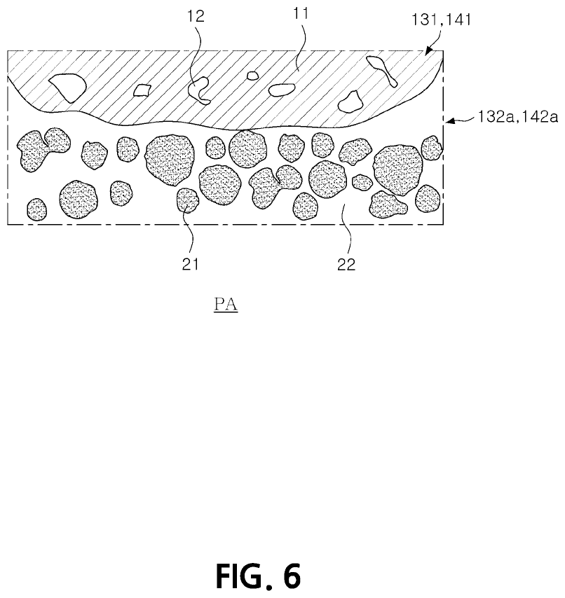

FIG. 6 is an enlarged view of region PA of FIG. 2.

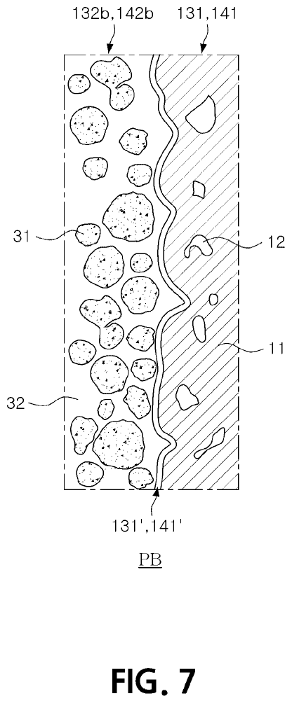

FIG. 7 is an enlarged view of region PB of FIG. 2.

Hereinafter, a multilayer electronic component 100 according to an embodiment of the present disclosure, a multilayer electronic component 100′ according to another embodiment of the present disclosure, and various examples thereof will be described in detail with reference to FIGS. 1 through 7.

The multilayer electronic component 100 according to an embodiment of the present disclosure and the multilayer electronic component 100′ according to another embodiment of the present disclosure may differ in the structure of external electrodes 130, 140, 130′, and 140′. However, other components excluding the external electrodes 130, 140, 130′, and 140′ may be substantially the same, and thus, redundant descriptions may be omitted.

The multilayer electronic component 100 according to an embodiment of the present disclosure may include a body 110 including a dielectric layer 111 and internal electrodes 121 and 122 alternately arranged with the dielectric layer 111 in the first direction and including a first surface 1 and a second surface 2 opposing each other in the first direction, a third surface 3 and a fourth surface 4 connected to the first surface 1 and the second surface 2 and opposing each other in the second direction, a fifth surface 5 and a sixth surface 6 connected to the first surface to the fourth surface 1, 2, 3, and 4 and opposing each other in the third direction and external electrodes 130 and 140 including electrode layers 131 and 141 disposed on the third surface 3 and the fourth surface 4 and including a conductive metal and conductive resin layers 132 and 142 disposed on the electrode layers 131 and 141, in which, when a region disposed on the third surface 3 or the fourth surface 4 is a connection portion A and a region disposed on the first surface 1 or the second surface 2 is a band portion B, the conductive resin layers 132 and 142 may include first conductive resin layers 132a and 142a disposed on the band portion B and including Cu 21 and a first resin 22 and second conductive resin layers 132b and 142b disposed on the connection portion A and including an intermetallic compound 31 and a second resin 32.

Referring to FIG. 2, the body 110 may include the dielectric layer 111 and the internal electrodes 121 and 122 alternately disposed with the dielectric layer 111 in the first direction.

While there are no particular limitations on the specific shape of the body 110, as illustrated, the body 110 may be formed in a hexahedral shape or a similar shape. Due to the shrinkage of ceramic powder particles included in the body 110 during a sintering process, the body 110 may not have a perfectly straight hexahedral shape but may have a substantially hexahedral shape.

The body 110 may have the first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first and second surfaces 1 and 2, connected to the third and fourth surfaces 3 and 4, and opposing each other in the third direction.

The plurality of dielectric layers 111 forming the body 110 are in a sintered state, and adjacent dielectric layers 111 may be integrated such that boundaries therebetween may not be readily apparent without using a scanning electron microscope (SEM).

According to an embodiment of the present disclosure, a raw material forming the dielectric layer 111 is not particularly limited as long as sufficient capacitance may be obtained. For example, a barium titanate-based material, a lead composite perovskite-based material, a calcium zirconate-based material, or a strontium titanate-based material may be used.

When a barium titanate-based material is used as a raw material forming the dielectric layer 111, the dielectric layer 111 may include a BaTiO₃-based ceramic material. Examples of the ceramic material include BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), or Ba(Ti_{1-y}Zr_{y}) O₃ (0<y<1) obtained by partially dissolving Ca (calcium), Zr (zirconium), etc., in BaTiO₃. Meanwhile, when a calcium zirconate-based material is used as a raw material for forming the dielectric layer 111, the dielectric layer 111 may include a CaZrO₃-based ceramic material.

Furthermore, the dielectric layer may include a BaTiO₃-based ceramic material and a CaZrO₃-based ceramic material, either alone or in combination.

Furthermore, the dielectric layer 111 may include various ceramic additives, organic solvents, binders, dispersants, etc., depending on the purpose of the present disclosure.

Meanwhile, since the dielectric layer 111 is in a sintered state, the ceramic powder used as a material for the dielectric layer 111 may form dielectric grains and grain boundaries.

Meanwhile, an average thickness td of the dielectric layer 111 may not be particularly limited. For example, to achieve miniaturization of the multilayer electronic component 100, the average thickness td of the dielectric layer 111 may be 0.35 μm or less. To ensure reliability of the multilayer electronic component 100 in a high-temperature, high-voltage environment, the average thickness td of the dielectric layer 111 may be 1 μm or greater.

Meanwhile, the average thickness td of the dielectric layer 111 may refer to the average thickness td of one or more of the plurality of dielectric layers 111.

The average thickness td of the dielectric layer 111 may be a value obtained by dividing a dielectric layer in the length direction into four equal parts, based on one dielectric layer adjacent to a point at which a central line of the capacitance forming portion in the length direction and a central line of the capacitance forming portion in the thickness direction intersect, among dielectric layers extracted from an image obtained by scanning a cross-section of the body 110 in the first and second directions polished to a central portion of the body 110 in the third direction using a scanning electron microscope (SEM), measuring thicknesses at ¼, 2/4, and ¾ points of the dielectric layer, and averaging the measured thicknesses. The average thickness of the dielectric layer may be further generalized by extending such measurement to the two upper and two lower dielectric layers, each spaced equally apart, based on one dielectric layer adjacent to the point at which the central line of the capacitance forming portion in the length direction and the central line of the capacitance forming portion in the thickness direction intersect.

Referring to FIG. 2, the internal electrodes 121 and 122 may be arranged alternately in the first direction with the dielectric layer 111 interposed therebetween.

The internal electrodes 121 and 122 may include first and second internal electrodes 121 and 122. The first and second internal electrodes 121 and 122 may be alternately arranged to face each other with the dielectric layer 111 forming the body 110 interposed therebetween and may be connected to the third and fourth surfaces 3 and 4 of the body 110, respectively. Specifically, one end of the first internal electrode 121 may be connected to the third surface 3, and one end of the second internal electrode 122 may be connected to the fourth surface 4. That is, in an embodiment, the internal electrodes 121 and 122 may be in contact with the third surface 3 or the fourth surface 4.

As illustrated in FIG. 2, the first internal electrode 121 may be spaced apart from the fourth surface 4 and exposed through (or expending from) the third surface 3, while the second internal electrode 122 may be spaced apart from the third surface 3 and exposed through (or expending from) the fourth surface 4. A first external electrode 130 may be disposed on the third surface 3 of the body and connected to the first internal electrode 121, and a second external electrode 140 may be disposed on the fourth surface 4 of the body and connected to the second internal electrode 122.

That is, the first internal electrode 121 may be connected to the first external electrode 131 without being connected to the second external electrode 132, and the second internal electrode 122 may be connected to the second external electrode 132 without being connected to the first external electrode 131. Accordingly, the first internal electrode 121 may be formed at a predetermined distance from the fourth surface 4, and the second internal electrode 122 may be formed at a predetermined distance from the third surface 3. Here, the first and second internal electrodes 121 and 122 may be electrically separated from each other by the dielectric layer 111 disposed therebetween.

A conductive metal included in the internal electrodes 121 and 122 may be a metal element with excellent electrical conductivity. For example, a first conductive metal (m) may be one or more of nickel (Ni), copper (Cu), palladium (Pd), silver (Ag), gold (Au), platinum (Pt), tin (Sn), tungsten (W), and titanium (Ti).

In addition, the internal electrodes 121 and 122 may be formed by printing a conductive paste for internal electrodes including one or more of nickel (Ni), copper (Cu), palladium (Pd), silver (Ag), gold (Au), platinum (Pt), tin (Sn), tungsten (W), titanium (Ti), and alloys thereof onto a ceramic green sheet. A printing method for the conductive paste for internal electrodes may be screen-printing or gravure printing, but the present disclosure is not limited thereto.

Meanwhile, the average thickness the of the internal electrodes 121 and 122 may not be particularly limited. For example, to achieve miniaturization of the multilayer electronic component 100, the average thickness the of the internal electrodes 121 and 122 may be 0.35 μm or less. To ensure reliability of the multilayer electronic component 100 in a high-temperature, high-voltage environment, the average thickness the of the internal electrodes 121 and 122 may be 1 μm or greater.

Meanwhile, the average thickness the of the internal electrodes 121 and 122 may refer to the average thickness the of one or more of the plurality of internal electrodes 121 and 122.

The average thickness the of the internal electrodes 121 and 122 may be a value obtained by dividing an internal electrode in the length direction into four equal parts, based on one internal electrode adjacent to a point at which a central line of the capacitance forming portion in the length direction and a central line of the capacitance forming portion in the thickness direction intersect, among internal electrodes extracted from an image obtained by scanning a cross-section of the body 110 in the first and second directions polished to a central portion of the body 110 in the third direction using a scanning electron microscope (SEM), measuring thicknesses at ¼, 2/4, and ¾ points of the internal electrode, and averaging the measured thicknesses. The average thickness of the internal electrode may be further generalized by extending such measurement to the two upper and two lower internal electrodes, each spaced equally apart, based on one internal electrode adjacent to the point at which the central line of the capacitance forming portion in the length direction and the central line of the capacitance forming portion in the thickness direction intersect.

Referring to FIG. 2, the body 110 may include a capacitance forming portion Ac disposed within the body 110 and including the first internal electrode 121 and second internal electrode 122 alternately arranged with the dielectric layer 111 therebetween to form capacitance and cover portions 112 and 113 disposed on one surface and the other surface of the capacitance forming portion Ac in the first direction.

The capacitance forming portion Ac contributes to the capacitance formation of the capacitor. As illustrated in FIG. 5, the capacitance forming portion Ac may be formed by repeatedly stacking a plurality of first and second internal electrodes 121 and 122 with the dielectric layer 111 therebetween.

Referring to FIG. 5, the cover portions 112 and 113 may be formed by stacking a single dielectric layer or two or greater dielectric layers on the upper and lower surfaces of the capacitance forming portion Ac in the thickness direction, respectively, and fundamentally serve to prevent damage to the internal electrodes due to physical or chemical stress.

The cover portions 112 and 113 may not include internal electrodes and may include the same material as that of the dielectric layer 111. That is, the cover portions 112 and 113 may include a ceramic material, for example, a barium titanate (BaTiO₃)-based ceramic material.

Meanwhile, an average thickness tc of the cover portions 112 and 113 may not be particularly limited. However, to facilitate miniaturization and high capacitance of the multilayer electronic component, the average thickness tc of the cover portions 112 and 113 may be 15 μm or less.

The average thickness of the cover portions 112 and 113 may refer to the size in the first direction and may be a value obtained by averaging sizes of the cover portions 112 and 113 in the first direction measured at five equally spaced points above or below the capacitance forming portion Ac.

In an embodiment, margin portions 114 and 115 may be disposed on one and the other surfaces of the capacitive forming portion Ac in the third direction.

Referring to FIG. 4, the margin portions 114 and 115 may include a margin portion 114 disposed on the fifth surface 5 of the body 110 and a margin portion 115 disposed on the sixth surface 6. That is, the margin portions 114 and 115 may be disposed on both end surfaces of the body 110 in the third direction (width direction).

Meanwhile, as illustrated in FIG. 4, the margin portions 114 and 115 may refer to a region between both ends of the first and second internal electrodes 121 and 122 and a boundary surface of the body 110.

The margin portions 114 and 115 may fundamentally serve to prevent damage to the internal electrodes due to physical or chemical stress.

The margin portions 114 and 115 may be formed by forming the internal electrodes by applying a conductive paste to a ceramic green sheet, excluding a region in which the margin portions are be formed.

In addition, to suppress a step difference caused by the internal electrodes 121 and 122, after stacking, cutting may be performed such that the internal electrodes are exposed to the fifth and sixth surfaces 5 and 6 of the body, and then, a single dielectric layer or two or greater dielectric layers may be stacked on both sides of the capacitance forming portion Ac in the third direction (width direction) to form the margin portions 114 and 115.

The width of the margin portions 114 and 115 may not be particularly limited. However, to facilitate miniaturization and high capacitance of multilayer electronic components, an average width of the margin portions 114 and 115 may be 15 μm or less.

The average width of the margin portions 114 and 115 may refer to the average size of the margin portions 114 and 115 in the third direction and may be a value obtained by averaging sizes of the margin portions 114 and 115 in the third direction measured at five equally spaced points on the side surface of the capacitance forming portion Ac.

Referring to FIG. 1, the external electrodes 130 and 140 are arranged on the body 110.

Referring to FIGS. 1 and 2, the external electrodes 130 and 140 may include the first external electrode 130 disposed on the body 110 and connected to the first internal electrode 121, and the second external electrode 140 disposed on the body 110 and connected to the second internal electrode 122 and spaced apart from the first external electrode 130.

Here, the direction in which the first external electrode 130 and the second external electrode 140 are spaced apart from each other may be considered the second direction.

In the present disclosure, a structure in which the multilayer electronic component 100 has two external electrodes 130 and 140 is described, but the number and shape of the external electrodes 130 and 140 may vary depending on the shape of the internal electrodes 121 and 122 or other purposes.

The external electrodes 130 and 140 may be disposed on the third surface 3 and the fourth surface 4 and may include electrode layers 131 and 141 including a conductive metal.

The electrode layers 131 and 141 may be in direct contact with at least a portion of the internal electrodes 121 and 122 to ensure electrical connectivity between the external electrodes 130 and 140 and the internal electrodes 121 and 122.

Referring to FIGS. 6 and 7, the electrode layers 131 and 141 may be sintered electrodes including a conductive metal 11 and glass 12, or although not illustrated in FIGS. 6 and 7, the electrode layers 131 and 141 may be plating layers including the conductive metal 11 but not the glass 12. That is, the electrode layers 131 and 141 may include conductive metal 11 and may further include the glass 12 in some cases.

The electrode layers 131 and 141 may be formed by dipping a conductive paste including the conductive metal and glass onto the body 110, transferring a sheet including the conductive metal, or by electroless plating on the body 110. However, the present disclosure is not limited thereto.

The conductive metal included in the electrode layers 131 and 141 may be any material with excellent electrical conductivity, and there are no particular limitations. For example, the conductive metal may be one or more of nickel (Ni), copper (Cu), and alloys thereof.

Referring to FIG. 2, conductive resin layers 132 and 142 may be disposed on the electrode layers 131 and 141. The conductive resin layers 132 and 142 may include metal and resin and may have a structure in which a metal is dispersed within a resin.

Since the conductive resin layers 132 and 142 include metals 21 and 31, they may be electrically connected to the electrode layers 131 and 141. Furthermore, since the conductive resin layers 132 and 142 include resins 22 and 32, the flexural strength of the multilayer electronic component 100 may be improved.

Meanwhile, the resins 22 and 32 included in the conductive resin layers 132 and 142 are likely to be non-conductive material or have lower electrical conductivity than metal, which may increase the equivalent series resistance (ESR) of the multilayer electronic component 100. Therefore, attempts have been made to form the entire conductive resin layers 132 and 142 as an intermetallic compound (IMC)-resin layer including IMC and a resin. However, IMC tends to form fine bridges between metal particles, which may be disadvantageous for improving flexural strength of the multilayer electronic component 100, as compared to when the entire conductive resin layers 132 and 142 are formed as a Cu-resin layer including copper and a resin.

Accordingly, in an embodiment of the present disclosure, an IMC-resin layer, which is advantageous for reducing the equivalent series resistance (ESR) of the multilayer electronic component 100, and a Cu-resin layer, which is advantageous for improving flexural strength, are organically arranged to simultaneously achieve both the effects of reducing the equivalent series resistance (ESR) and improving flexural strength of the multilayer electronic component 100.

First, the external electrodes 130 and 140 according to an embodiment of the present disclosure may be divided into several regions depending on their placement on the body 110. Specifically, referring to FIG. 2, the external electrodes 130 and 140 may be divided into a connection portion A, which is disposed on the third surface 3 or the fourth surface 4, and a band portion B, which is located on the first surface 1 or the second surface 2.

The connection portion A may be a region connected to the internal electrodes and may have low resistance to be advantageous for reducing the ESR of the multilayer electronic component 100. Since the band portion B is disposed on the first surface 1 or the second surface 2 (or on the fifth surface 5 or the sixth surface 6) of the body 110, the band portion B may have superior mechanical strength or ductility to be advantageous for improving the flexural strength of the multilayer electronic component 100.

According to an embodiment of the present disclosure, the conductive resin layers 132 and 142 may include first conductive resin layers 132a and 142a disposed on the band portion B and including the Cu 21 and the first resin 22, and second conductive resin layers 132b and 142b disposed on the connection portion A and including the intermetallic compound 31 and the second resin 32.

The first conductive resin layers 132a and 142a include the Cu 21 and the first resin 22, and thus may have better ductility and mechanical strength than the second conductive resin layers 132b and 142b including the intermetallic compound 31 and the second resin 32, and the second conductive resin layers 132b and 142b include the intermetallic compound 31 and the second resin 32 having a high tendency to form bridges between particles, and thus may have lower resistance than the first conductive resin layers 132a and 142a.

According to an embodiment of the present disclosure, the first conductive resin layers 132a and 142a having excellent mechanical strength and ductility are formed on the band portion B requiring excellent mechanical strength and ductility, and the second conductive resin layers 132b and 142b having low resistance are formed on the connection portion A requiring low resistance, thereby improving the flexural strength of the multilayer electronic component 100, while simultaneously suppressing an increase in the equivalent series resistance (ESR).

Meanwhile, although not illustrated in FIG. 2, the external electrodes 130 and 140 according to an embodiment may include a side band portion, a region disposed on the fifth surface 5 and the sixth surface 6.

The type of intermetallic compound 31 included in the second conductive resin layer is not particularly limited. For example, the intermetallic compound 31 may include one or more of a Ni—Sn intermetallic compound, an Ag—Sn intermetallic compound, and a Cu—Sn intermetallic compound.

Meanwhile, examples of Ni—Sn intermetallic compound may include Ni₃Sn and Ni₃Sn₄, examples of Ag—Sn intermetallic compound may include Ag₃Sn, and examples of Cu—Sn intermetallic compound may include Cu₆Sn₅ and Cu₃Sn, but the present disclosure is not limited thereto.

The first resin 22 and the second resin 32 may be, for example, thermosetting resins. The thermosetting resin may include, for example, an epoxy resin, but the present disclosure is not limited thereto. For example, the thermosetting resin may be a resin having a low molecular weight and being liquid at room temperature, such as bisphenol A resin, glycol epoxy resin, novolac epoxy resin, or derivatives thereof.

Since the second conductive resin layers 132b and 142b are disposed in the connection portion A of the external electrodes 130 and 140 and the first conductive resin layers 132a and 142a are disposed in the band portion B of the external electrodes 130 and 140, even if the proportion of the intermetallic compound 31 in the second conductive resin layers 132b and 142b increases, a decrease in the flexural strength of the multilayer electronic component 100 may be suppressed and the equivalent series resistance (ESR) of the multilayer electronic component 100 may be further reduced.

Meanwhile, the proportion of the intermetallic compound 31 in the second conductive resin layers 132b and 142b may be expressed as the area fraction of the intermetallic compound 31 in the second conductive resin layers 132b and 142b. In an embodiment, the area fraction of the intermetallic compound 31 in the second conductive resin layers 132b and 142b may be greater than the area fraction of the Cu 21 in the first conductive resin layers 132a and 142a.

In an embodiment, the area fraction of the Cu 21 in the first conductive resin layers 132a and 142a may be 0.50 or greater, more preferably 0.80 or greater. Meanwhile, an upper limit of the area fraction of the Cu 21 in the first conductive resin layers 132a and 142a is not particularly limited and may be, for example, 0.95 or less.

In an embodiment, the area fraction of the intermetallic compound 31 in the second conductive resin layers 132b and 142b may be 0.50 or greater, more preferably 0.80 or greater. Accordingly, the effect of reducing the equivalent series resistance (ESR) of the multilayer electronic component 100 may become more remarkable. Meanwhile, when the second conductive resin layers 132b and 142b are formed in both the connection portion A and the band portion B, if the area fraction of the intermetallic compound 31 is 0.50 or greater, or 0.80 or greater, the flexural strength of the multilayer electronic component 100 may be reduced due to excessive connection between particles of the intermetallic compound 31. However, according to an embodiment of the present disclosure, since the second conductive resin layers 132b and 142b are formed in the connection portion A and the first conductive resin layers 132a and 142a are formed in the band portion B, a decrease in the flexural strength of the multilayer electronic component 100 may be suppressed even if excessive connection between particles of the intermetallic compound 31 is formed.

Meanwhile, an upper limit of the area fraction of the intermetallic compound 31 in the second conductive resin layers 132b and 142b is not particularly limited. For example, the area fraction of the intermetallic compound 31 in the second conductive resin layers 132b and 142b may be 0.95 or less.

The area fraction of the Cu 21 of the first conductive resin layers 132a and 142a and the area fraction of the intermetallic compound 31 in the second conductive resin layers 132b and 142b may be obtained by imaging a plurality of points in a 60 μm×60 μm region of the central spot of the first conductive resin layers 132a and 142a in the second direction and a 60 μm×60 μm region of central spot of the second conductive resin layers 132b and 142b in the first direction without overlapping positions, based on the cross-section in the first and second directions polished to a ½ point of the multilayer electronic component 100 in the third direction and then measuring the size of the contrast using a computer program, such as ImageJ, to obtain an average value. However, the present disclosure is not limited thereto.

Meanwhile, the method of measuring the composition of the intermetallic compound 31 in the second conductive resin layers 132b and 142b is not particularly limited. For example, in the cross-section of the multilayer electronic component 100 in the first and second directions polished to ½ point in the third direction, the 60 μm×60 μm region at the center spot of the second conductive resin layers 132b and 142b in the first direction may be imaged using a scanning electron microscope (SEM), and then, each component may be mapped using EDS mode to conduct quantitative/qualitative analysis. In this case, the content of each element may be expressed, for example, in mass percentage (wt %), atomic percentage (at %), or mole percentage (mol %), and the content of another specific component with respect to the content of a specific component may also be expressed.

The second conductive resin layers 132b and 142b may preferably be formed in at least a certain portion of the connection portion A to enhance the effect of reducing the equivalent series resistance (ESR) of the multilayer electronic component 100. Specifically, when the maximum size of the body 110 in the first direction is T, the second conductive resin layers 132b and 142b may be disposed in upper and lower regions of 0.3 T or greater from the central portion of the body 110 in the first direction.

In an embodiment, end portions of the first conductive resin layers 132a and 142a and the second conductive resin layers 132b and 142b may be in contact with each other. The end portion in which the first conductive resin layers 132a and 142a and the second conductive resin layers 132b and 142b contact each other may be formed in the band portion B, as illustrated in FIG. 2. However, the present disclosure is not limited thereto, and the end portion in which the first conductive resin layers 132a and 142a and the second conductive resin layers 132b and 142b contact each other may also be formed in a corner portion C of the external electrodes 130 and 140 or a boundary between the band portion B and the corner portion C.

Referring to FIGS. 2 and 3, the external electrodes 130, 140, 130′, and 140′ may include the corner portion C, a region connecting the connection portion A and the band portion B. In this case, the first conductive resin layers 132a and 142a may be disposed in the band portion B, as illustrated in FIG. 2, so as not to extend beyond the corner portion C. Accordingly, the effect of reducing the equivalent series resistance (ESR) of the multilayer electronic component 100 may be remarkable.

Referring to FIG. 3, the multilayer electronic component 100′ according to another embodiment of the present disclosure may include external electrodes 130′ and 140′ arranged on the body 110. The external electrodes 130′ and 140′ may be arranged on the third surface 3 and the fourth surface 4 and may include the electrode layers 131 and 141 including a conductive metal and conductive resin layers 132′ and 142′ arranged on the electrode layers 131 and 141.

Referring to FIG. 3, the conductive resin layers 132′ and 142′ may include first conductive resin layers 132a′ and 142a′ disposed in the band portion B of the external electrodes 130′ and 140′ and including Cu and a first resin and second conductive resin layers 132b′ and 142b′ disposed in the connection portion A of the external electrodes 130′ and 140′ and including an intermetallic compound and a second resin.

Meanwhile, referring to FIG. 3, the external electrodes 130′ and 140′ may include the corner portion C, a region connecting the connection portion A to the band portion B. In this case, the first conductive resin layers 132a′ and 142a′ may extend from the band portion B to the corner portion C, as illustrated in FIG. 3. Accordingly, the effect of improving flexural strength of the multilayer electronic component 100 may become remarkable.

In an embodiment, plating layers 133, 134, 143, and 144 may be disposed on the conductive resin layers 132, 142, 132′, and 142′.

The plating layers 133, 134, 143, and 144 may improve the sealing and mounting characteristics of the multilayer electronic component 100 and 100′.

Referring to FIGS. 2 and 3, the plating layers 133, 134, 143, and 144 may cover the end portions of the conductive resin layers 132, 143, 132′, and 142′, thereby preventing a decrease in the moisture resistance reliability of the multilayer electronic component 100.

The type of plating layers 133, 134, 143, and 144 is not particularly limited. The plating layers 133, 134, 143, and 144 may include one or more of Ni, Sn, Pd, and alloys thereof and may be formed as a plurality of layers.

For more specific examples, the plating layers 133, 134, 143, and 144 may have a form in which Ni plating layers 133 and 142 and Sn plating layers 134 and 144 are sequentially disposed on the conductive resin layer 132, 142, 132′, and 142′ or in a form in which an Sn plating layer, a Ni plating layer, and an Sn plating layer are sequentially formed. Furthermore, the plating layers may include a plurality of Ni plating layers and/or a plurality of Sn plating layers.

The method of forming the plating layers 133, 134, 143, and 144 is not particularly limited, and for example, electroless plating, electrolytic plating, etc. may be used.

Since the second conductive resin layers 132b, 142b, 132b′, and 142b′ include an intermetallic compound (IMC), some of metal elements in the intermetallic compound (IMC) may form an alloy with the conductive metal of the first electrode layers 131 and 141, and accordingly, the interlayer adhesion and electrical connectivity of the external electrodes 130 and 140 may be improved. Specifically, in the embodiment referring to FIG. 7, intermediate layers 131′ and 141′ may be disposed between the first electrode layers 131 and 141 and the second conductive resin layers 132b, 142b, 132b′, and 142b′.

The intermediate layers 131′ and 141′ may be formed by some metal elements of the intermetallic compound (IMC) 31 migrating or diffusing toward the electrode layers 131 and 141 to form an alloy with the conductive metal 11 included in the electrode layers 131 and 141. Specifically, in an embodiment, the intermediate layers 131′ and 141′ may include one or more of a Ni—Sn intermetallic compound, an Ag—Sn intermetallic compound, and a Cu—Sn intermetallic compound.

Meanwhile, the types of intermetallic compounds 31 included in the intermediate layers 131′ and 141′ and the second conductive resin layers 132b, 142b, 132b′, and 142b′ do not necessarily have to be the same and may be different.

In the present disclosure, a method of controlling the formation regions of the first conductive resin layers 132a, 142a, 132a′, and 142a′ and the second conductive resin layers 132b, 142b, 132b′, and 142b′ is not particularly limited. For example, a method of controlling printing or dipping regions of the first conductive resin layers 132a, 142a, 132a′, and 142a′ and the second conductive resin layers 132b, 142b, 132b′, and 142b′ may be used.

For example, after the electrode layers 131 and 141 are formed on the body 110, the second conductive resin layers 132b, 142b, 132b′, and 142b′ are formed in a designed region through wheel-type application and curing is performed. Thereafter, the body 110 on which the electrode layers 131 and 141 and the second conductive resin layers 132b, 142b, 132b′, and 142b′ are formed may be dipped to form the first conductive resin layers 132a, 142a, 132a′, and 142a′, and then the region of the first conductive resin layers 132a, 142a, 132a′, and 142a′ formed in the connection portion may be wiped or removed, thereby controlling the formation region of the first conductive resin layers 132a, 142a, 132a′, and 142a′ and the second conductive resin layers 132b, 142b, 132b′, and 142b′.

Meanwhile, in a case in which the first conductive resin layers 132a, 142a, 132a′, and 142a′ are disposed so as not to extend beyond the corner portion of the external electrode, a method of forming the second conductive resin layers 132b, 142b, 132b′, and 142b′ by a dipping method, wiping or removing the second conductive resin layers 132b, 142b, 132b′, and 142b′ in the region of the connection portion, and then forming the first conductive resin layers 132a, 142a, 132a′, and 142a′ by a dipping method may be used.

### Experimental Example 1

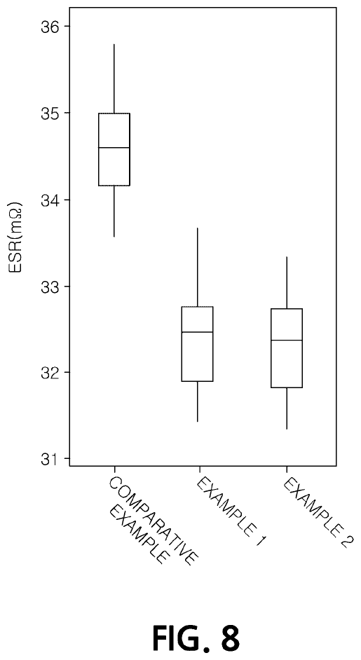

FIG. 8 is a graph illustrating the results of measuring equivalent series resistance (ESR) in multilayer electronic components according to comparative example and examples.

The comparative example in FIG. 8 represents a case in which the area fraction of the intermetallic compound 31 is the smallest. Example 1 represents a case in which the area fraction of the intermetallic compound 31 is higher than that of the comparative example, and Example 2 represents a case in which the area fraction of the intermetallic compound 31 is higher than that of Example 1.

Referring to FIG. 8, it can be seen that the equivalent series resistance (ESR) of the multilayer electronic components decreases as the area fraction of the intermetallic compound 31 increases.

### Experimental Example 2

Table 1 illustrates capacitance values according to flexural strength measurement distances for samples of a multilayer electronic component in which an IMC-resin layer was formed entirely on the electrode layer, and Table 2 illustrates capacitance values according to flexural strength measurement distances for samples of a multilayer electronic component in which an IMC-resin layer was formed in the connection portion and a Cu-resin layer was formed in the band portion.

The flexural strength evaluation was conducted by measuring the capacitance according to a measurement distance (strain) under AEC-Q200 measurement conditions. A constant load (1 mm/min) was applied to the center using a three-point bending tester at 25° C.

In Table 1 and Table 2, a case in which the capacitance value decreased to 1/10 of the initial insulation resistance value was evaluated as NG.

For the samples in Tables 1 and 2, copper, glass, and a binder were mixed and dispersed with a 3-roll mill to prepare a Cu paste, and then the Cu paste was sintered at 650 to 850° C. to produce primary electrode sintered chips.

Thereafter, each sample in Table 1 was manufactured by mixing Cu powder, Sn powder, and epoxy resin, dispersing the mixture using a 3-roll mill to prepare a low-melting-point paste, forming the prepared paste on the electrode layers 131 and 141 by a dipping method, raising the temperature to 280° C. at a heating rate of 4.6° C./min, performing curing, while maintaining the raised temperature, and then forming a Ni plating layer and a Sn plating layer.

For each sample in Table 2, Cu powder, Sn powder, and epoxy resin were mixed and dispersed using a 3-roll mill to prepare a low-melting-point paste, which was then applied to a head surface of the same primary electrode sintered chip using a wheel type application, and curing was performed by raising temperature to 280° C. at a heating rate of 4.6° C./min and maintaining the raised temperature. Thereafter, Cu powder and epoxy resin were mixed and dispersed using a 3-roll mill, to prepare a paste, which was then applied to the head surface and upper surface of the body 110 by a dipping method, and the Cu-epoxy paste formed on the head surface was removed, and then, curing was performed by raising temperature to 280° C. at a heating rate of 4.6° C./min and maintaining the raised temperature.

Meanwhile, the Sn powder may include one or more selected from Sn, Sn_{96.5}Ag_{3.0}Cu_{0.5}, Sn₄₂Bi₅₈, and Sn₇₂Bi₂₈. The average particle size of the Cu powder particles and Sn powder particles may range from 0.3 μm to 10 μm, but powder particles having the same particle size were used in all samples according to Tables 1 and 2.

TABLE 1

| Sample | Change in capacitance according to flexural strength measurement distance (μF) | | | | | | | | | |
|---|---|---|---|---|---|---|---|---|---|---|
| No. | Early stage | 2 mm | 3 mm | 4 mm | 5 mm | 6 mm | 7 mm | 8 mm | 9 mm | 10 mm |

| | | | | | | | |
|---|---|---|---|---|---|---|---|
| 1 | 101.2 | 99.1 | 98.7 | NG | | | |
| 2 | 100.2 | 99.6 | 99.5 | 98.9 | 98.1 | NG | |
| 3 | 98.34 | 97.7 | 97.3 | 96.9 | NG | | |
| 4 | 99.9 | 100 | 99 | 98 | NG | | |
| 5 | 100.6 | 99.6 | 99.4 | 98.6 | NG | | |
| 6 | 100.6 | 99 | 98.7 | NG | | | |
| 7 | 100.9 | 99 | 98.8 | 98 | NG | | |
| 8 | 101.5 | 99.5 | 99.3 | NG | | | |
| 9 | 99.6 | 97 | 97.5 | 96.6 | 98 | 98.4 | NG |
| 10 | 101.1 | 99.6 | 99 | 98.1 | 100 | NG | |

TABLE 2

| Sample | Change in capacitance according to flexural strength measurement distance (μF) | | | | | | | | | |
|---|---|---|---|---|---|---|---|---|---|---|
| No. | Early stage | 2 mm | 3 mm | 4 mm | 5 mm | 6 mm | 7 mm | 8 mm | 9 mm | 10 mm |
| 1 | 101.2 | 99.9 | 101.1 | 101.4 | 101.1 | NG | | | | |
| 2 | 100.7 | 99.1 | 99 | 100.5 | 100.4 | 100.2 | 100 | 99.9 | 99.8 | 99.7 |
| 3 | 100.8 | 99.6 | 99.4 | 101 | 100.7 | 100.4 | 100.3 | 100.2 | 100.1 | NG |
| 4 | 100.7 | 101.1 | 99.1 | 100.5 | 100.6 | 100.4 | 100.2 | NG | | |
| 5 | 100 | 99.1 | 99.7 | 100.2 | 100.6 | 100.3 | 99.9 | 99.8 | 99.6 | 99.6 |
| 6 | 100.7 | 99.6 | 99.4 | 101 | 101 | 100.8 | 100.6 | 100.4 | NG | |
| 7 | 99.6 | 99 | 98.4 | 100 | 99.4 | 99.4 | NG | | | |
| 8 | 100.4 | 99.2 | 100.3 | 100.7 | 100.5 | NG | | | | |
| 9 | 100.8 | 99.8 | 99.5 | 101 | 100.8 | 100.6 | NG | | | |
| 10 | 100.8 | 99.7 | 100.7 | 101 | 101 | 100.8 | 100.5 | NG | | |

Referring to Table 1, it can be seen that, when the IMC-resin layer was formed entirely in the band portion and connection portion, three out of ten samples failed (NG) at 4 mm during the flexural strength test, and all samples failed (NG) at 7 mm of deformation.

Referring to Table 2, it can be seen that, when the Cu-resin layer was formed in the band portion and the IMC-resin layer is formed in the connection portion, no sample failed (NG) at 4 mm, and the deformation in which the capacitance value first failed (NG) corresponds to 6 mm. Furthermore, it can be seen that, even at 10 mm of deformation, capacitance values of samples 2 and 5 did not fail (NG).

That is, it can be seen that, when the Cu-resin layer is formed in the band portion of the external electrode and the IMC-resin layer is formed in the connection portion of the external electrode, as in an embodiment of the present disclosure, degradation of flexural strength may be suppressed.

One of the various effects of the present disclosure is to secure flexural strength of a multilayer electronic component and suppress an increase in ESR by disposing the first conductive resin layer including Cu and the first resin in the band portion of the external electrode and disposing the second conductive resin layer including the intermetallic compound and the second resin in the connection portion.

However, various advantages and effects of the present disclosure are not limited to the above-described contents and will be more readily understood as specific embodiments of the present disclosure are described.

Although the embodiments of the present disclosure have been described in detail above, the present disclosure is not limited to the embodiments described above and the accompanying drawings, but is intended to be limited by the appended claims. Accordingly, various forms of substitution, modification, and change may be made by those skilled in the art within the scope without departing from the technical idea of the present disclosure described in the claims, and this will also be considered to fall within the scope of the present disclosure.

The expression “an embodiment or an example” used in the present disclosure does not refer to identical examples and is provided to stress different unique features between each of the examples. However, examples provided in the following description are not excluded from being associated with features of other examples and implemented thereafter. For example, even if matters described in a specific example are not described in a different example thereto, the matters may be understood as being related to the other example, unless otherwise mentioned in descriptions thereof.

The terms used herein are for the purpose of describing particular embodiments only and are not intended to limit the embodiments. As used herein, the singular forms “a,” “an,” and “the” are intended to include the plural forms as well, unless the context clearly indicates otherwise.

What is claimed is:

1. A multilayer electronic component comprising:
a body including a dielectric layer and internal electrodes alternately arranged with the dielectric layer in a first direction, the body including first and second surfaces opposing each other in the first direction, third and fourth surfaces connected to the first and second surfaces and opposing each other in a second direction, and fifth and sixth surfaces connected to the first to fourth surfaces and opposing each other in a third direction; and
an external electrode disposed on one of the third surface or the fourth surface and including an electrode layer including a conductive metal and a conductive resin layer disposed on the electrode layer,
wherein the external electrode includes a connection portion disposed on the one of the third surface or the fourth surface and a band portion disposed on the first surface or the second surface, and
the conductive resin layer includes a first conductive resin layer disposed in the band portion and including Cu and a first resin and a second conductive resin layer disposed in the connection portion and including an intermetallic compound and a second resin.

2. The multilayer electronic component of claim 1, wherein the intermetallic compound includes at least one of a Ni—Sn intermetallic compound, an Ag—Sn intermetallic compound, and a Cu—Sn intermetallic compound.

3. The multilayer electronic component of claim 1, wherein an area fraction of the intermetallic compound in the second conductive resin layer is greater than an area fraction of the Cu in the first conductive resin layer.

4. The multilayer electronic component of claim 1, wherein an area fraction of the intermetallic compound in the second conductive resin layer is 0.50 or greater and 0.95 or less.

5. The multilayer electronic component of claim 1, wherein an area fraction of the Cu in the first conductive resin layer is 0.50 or greater and 0.95 or less.

6. The multilayer electronic component of claim 1, wherein end portions of the first conductive resin layer and the second conductive resin layer are in contact with each other.

7. The multilayer electronic component of claim 1, wherein the external electrode further includes a corner portion connecting the connection portion to the band portion, and
the first conductive resin layer is disposed to extend from the band portion to the corner portion.

8. The multilayer electronic component of claim 1, wherein the external electrode further includes a corner portion connecting the connection portion to the band portion, and
the second conductive resin layer is disposed to extend from the connection portion to the corner portion.

9. The multilayer electronic component of claim 1, wherein a maximum size of the body in the first direction is T, and the second conductive resin layer is disposed from a central portion of the body in the first direction to upper and lower regions of 0.3 T or greater from the central portion of the body in the first direction.

10. The multilayer electronic component of claim 1, wherein the external electrode includes a plating layer disposed on the conductive resin layer.

11. The multilayer electronic component of claim 10, wherein the plating layer covers an end portion of the conductive resin layer.

12. The multilayer electronic component of claim 1, wherein the electrode layer further includes glass.

13. The multilayer electronic component of claim 1, wherein the external electrode further includes an intermediate layer disposed between the second conductive resin layer and the electrode layer.

14. The multilayer electronic component of claim 13, wherein the intermediate layer includes one or more of a Ni—Sn intermetallic compound, an Ag—Sn intermetallic compound, and a Cu—Sn intermetallic compound.

15. The multilayer electronic component of claim 1, wherein the first resin and the second resin include a thermosetting resin.

16. A multilayer electronic component comprising:
a body including a dielectric layer and internal electrodes alternately arranged with the dielectric layer in a first direction, the body including first and second surfaces opposing each other in the first direction, third and fourth surfaces connected to the first and second surfaces and opposing each other in a second direction, and fifth and sixth surfaces connected to the first to fourth surfaces and opposing each other in a third direction; and
an external electrode disposed on one of the third surface of the fourth surface and including an electrode layer including a conductive metal and a conductive resin layer disposed on the electrode layer,
wherein the external electrode includes a connection portion disposed on the one of the third surface or the fourth surface and a band portion disposed on the first surface or the second surface,
an intermetallic compound and Cu are dispersed in a resin of the conductive resin layer, and
a content of the intermetallic compound with respect to the resin in the connection portion is greater than a content of the intermetallic compound with respect to the resin in the band portion, and a content of the Cu with respect to the resin in the connection portion is less than a content of the Cu with respect to the resin in the band portion.

17. The multilayer electronic component of claim 16, wherein the intermetallic compound includes at least one of a Ni—Sn intermetallic compound, an Ag—Sn intermetallic compound, and a Cu—Sn intermetallic compound.

18. The multilayer electronic component of claim 16, wherein an area fraction of the intermetallic compound in the connection portion is greater than an area fraction of the Cu in the band portion.

19. The multilayer electronic component of claim 16, wherein an area fraction of the intermetallic compound in the connection portion is 0.50 or greater and 0.95 or less, and
an area fraction of the Cu in the band portion is 0.50 or greater and 0.95 or less.

20. The multilayer electronic component of claim 16, wherein the external electrode includes a plating layer disposed on the conductive resin layer.
